(19) United States
(12) Patent Application Publication
(10) Pub. No.: US 2013/0168579 A1
(43) Pub. Date: Jul. 4, 2013

(54) FLUID REGULATING VALVE

(71) Applicants: TIN-KAI LIN, Taichung City (TW); JYUNG-YING HUANG, Chiayi County (TW); DA-YU LIN, Taichung City (TW)

(72) Inventors: TIN-KAI LIN, Taichung City (TW); JYUNG-YING HUANG, Chiayi County (TW); DA-YU LIN, Taichung City (TW)

(73) Assignee: METAL INDUSTRIES RESEARCH & DEVELOPMENT CENTRE, KAOHSIUNG CITY (TW)

(21) Appl. No.: 13/339,572

(22) Filed: Dec. 29, 2011

(51) Int. Cl. F16K 31/12

(52) U.S. Cl. 251/12

(57) ABSTRACT

The present invention relates to fluid regulating valve, comprising a housing, a flow regulating member, and a gap controlling member. The housing has an inlet and a carrying part having a first outlet. The gap controlling member is located between the flow regulating member and the carrying part for regulating the gap between the carrying part and the flow regulating member. Fluid flows into the housing via the inlet, flows into the gap via the flow regulating member, drains off from the first outlet, and the fluid pressure of the fluid exerts pressure on the gap controlling member via the flow regulating member for controlling the flow rate of the fluid draining off the first outlet via the gap within a predetermined range by adjusting gap size using said gap controlling member. The fluid regulating valve according to the present invention is tolerant to damages in long-term usage.

### FIELD OF THE INVENTION

The present invention relates generally to a regulating valve, and particularly to a fluid regulating valve.

### BACKGROUND OF THE INVENTION

Owing to the global warming effect, extraordinary phenomena of extreme weather occur in various countries. For example, large-area droughts happen in Asia. Farther, the American area appears floods. In addition, Taiwan is not exempt from the disasters. In Taiwan, long-term lack of rains resulted in significant decrease in rainfall. According to the official statistics, over a half of domestic reservoirs encounter the silt problem and leading to insufficient water storage. Consequently, the policy of water rationing has to be adopted in Taiwan, which will impose inconvenience to people's lives as well bringing serious loss to industrial development. Thereby, how to reserve and spare water resources has become an important subject.

Besides, due to different hydraulic pressure in different areas, the water usage in different area differs. For example, in an area with higher hydraulic pressure, the flow rate of water is higher. As a result, the water usage in the area is relatively higher, leading to high expenses of the users in this area. In addition, imperceptibly, water tends to be wasted.

Accordingly, a flow regulator is developed nowadays. The flow regulator can regulate the flow rate of fluid for achieving the effects of reserving and sparing water resources. Currently, there exist many kinds of flow regulators. For example, the “Insertion part for inserting into a gap or liquid line” as disclosed in the US patent publication number 2006/0086397 comprises a housing and a lip shaped part. The exterior circumference of the lip shaped part is annular for being held in the interior circumference of the housing. Besides, the lip shaped part has an annular control lip end facing the interior sidewall of the housing. Thereby, when fluid flows, pressure will be exerted at the annular control lip end and thus modulating the spacing between the annular control lip end and the adjacent sidewall of the housing. Accordingly, the flow rate out of the bore can be modulated.

The lip shaped part of the insertion part is made by elastic materials. The regulating principle of the insertion part is that the angle of the control lip end of the lip shaped part changes according to the flow pressure. Thereby, the purpose of adjusting the flow rate out of the bore can be achieved. Nonetheless, during the modulating process, the control lip end is likely to crack because it modulates its angles frequently. Thereby, the real flow rate does not comply with the predetermined one. When a heated fluid flows into the insertion part for modulating its flow rate, the damaging rate of the insertion part will be accelerated. Moreover, as the control lip end is struck frequently by high-speed fluids, regular vibration occurs owing to pressure difference or uneven pressure on the control lip end. Consequently, the control lip end is prone to breakage or tear damages.

For solving the problems described above, the present invention provides a fluid regulating valve, which can regulate the flow rate according to the pressure of fluid so that, whatever the fluid pressure is, the flow rate of the fluid supplied by the fluid regulating valve is controlled within a predetermined range. The fluid regulating valve according to the present invention is tolerant to damages in long-term usage, and hence endowed with high reliability. Furthermore, the fluid regulating valve according to the present invention has a simple structure with few components. Accordingly, it is easy for assembling and modularization.

### SUMMARY

An objective of the present invention is to provide a fluid regulating valve, whose structure is tolerant to damages in long-term usage. Thereby, the fluid regulating valve according to the present invention has high reliability.

Another objective of the present invention is to provide a fluid regulating valve, whose structure is simple with few components. Thereby, the fluid regulating valve according to the present invention is easy for assembling and modularization,

Still another objective of the present invention is to provide a fluid regulating valve, which can regulate the flow rate of fluid according to the fluid pressure and control the flow rate of the fluid supplied by the fluid regulating valve to be within a predetermined range whatever the fluid pressure is.

For achieving the objectives described above, the fluid regulating valve provided by the present invention comprises a housing, a flow regulating member, and a gap controlling member. The housing has an inlet and a carrying part, where the carrying part forms a first outlet. The flow regulating member is disposed in the housing and located between the inlet and the first outlet for transferring a fluid pressure of a fluid. The gap controlling member is an elastic element and is located in the housing. The gap controlling member is adjacent to and between the carrying part and the flow regulating member for regulating the gap between the carrying part and the flow regulating member. Besides, the inlet and the first outlet connect with the gap. The fluid flows into the housing via the inlet and into the gap by transferring the flow regulating member, and then flows out from the first outlet. The fluid pressure of the fluid is exerted on the gap controlling member through the flow regulating member. The gap controlling member is then used for adjusting the size of the gap, and thus controlling the flow rate of the fluid out of the first outlet via the gap.

### BRIEF DESCRIPTION OF THE DRAWINGS

FIG. 1 shows a three-dimensional view according to the first embodiment of the present invention;

FIG. 2 shows an exploded view according to the first embodiment of the present invention;

FIG. 3 shows a partial cross-sectional view according to the first embodiment of the present invention;

FIG. 4 shows a schematic diagram of the fluid regulating valve installed in a pipe according to the first embodiment of the present invention;

FIG. 5A and FIG. 5B show usage diagrams according to the first embodiment of the present invention;

FIG. 6 shows a partial cross-sectional view according to the second embodiment of the present invention;

FIG. 7 shows an exploded view according to the third embodiment of the present invention;

FIG. 8 shows a partial cross-sectional view according to the third embodiment of the present invention;

FIG. 9 shows a cross-sectional view from another angle according to the third embodiment of the present invention;

FIG. 10 shows an exploded view according to the fourth embodiment of the present invention; and

FIG. 11 shows a partial cross-sectional view according to the fourth embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The structure of the flow regulator according to the prior art is prone to damages if struck by fluids in the long run, resulting in lowering of its reliability. Thereby, the present invention provides a fluid regulating valve, which is tolerant to damages under long-term strikes of fluids. Accordingly, the fluid regulating valve according to the present invention has high reliability.

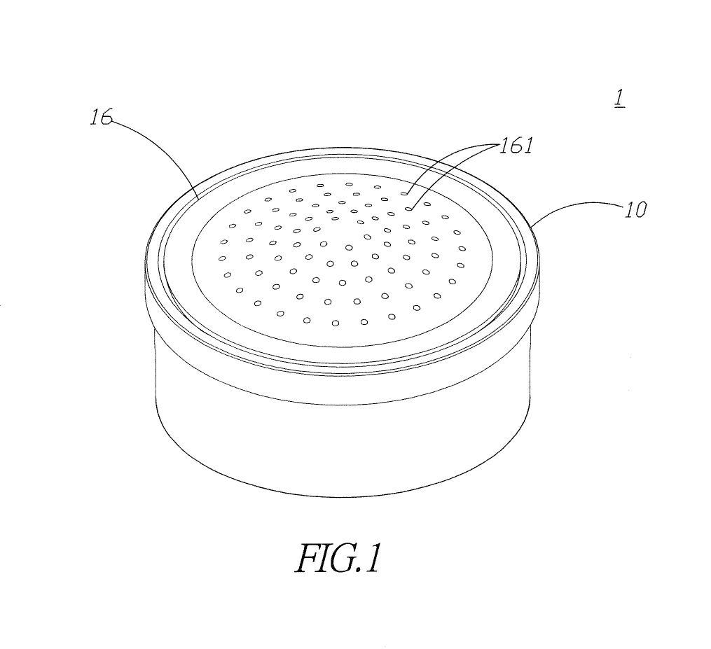

FIGS. 1, 2, and 3 show three-dimensional, exploded, and partial cross-sectional views according to a first embodiment of the present invention. As shown in the figures, the fluid regulating valve 1 according to the present invention at least comprises a housing 10, a gap controlling member 12, and a flow regulating member 14. The housing 10 has a carrying part 101 and a surrounding sidewall 102. The surrounding sidewall 102 surrounds the circumference of the carrying part 101 and forms a hollow body. According to an embodiment of the present invention, the surrounding sidewall 102 and the carrying part 101 are further formed integrally. The top of the surrounding sidewall 102 is an opening, which forms an inlet 103. In addition, a first outlet 104 and a second outlet 105 are formed on the carrying part 101.

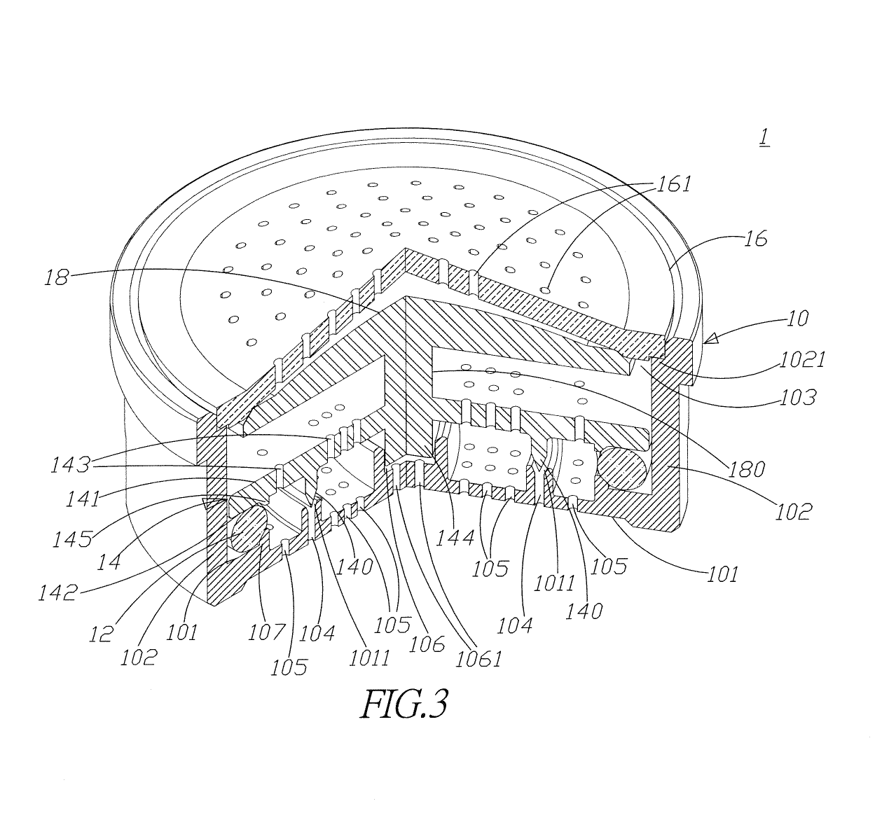

Refer to FIG. 3. The flow regulating member 14 is disposed in the housing 10 and located between the inlet 103 and the first and second outlets 104, 105 for pass a fluid pressure of a fluid on. A gap is located between the carrying part 101 and the flow regulating member 14; the inlet 103, the first outlet 104, and the second outlet 105 connect with the gap. The gap controlling member 12 is an elastic element and is located in the housing 10. The gap controlling member 12 is adjacent to and between the carrying part 101 and the flow regulating member 14, namely, in the gap between the carrying part 101 and the flow regulating member 14, for regulating the size of the gap between the carrying part 101 and the flow regulating member 14.

When the fluid enters the fluid regulating valve 1, the fluid first flows into the housing 10 via the inlet 103. Next, it flows into the gap between the carrying part 101 and the flow regulating member 14 through the flow regulating member 14. Finally, the fluid flows out from the first and second outlets 104, 105. By taking advantage of the fluid pressure exerted by the fluid on the fluid regulating member 14, the flow regulating member 14 of the fluid regulating valve 1 according to the present embodiment moves towards the direction of the gap controlling member 12 and presses, namely, exerting pressure, on the gap controlling member 12. Because the gap controlling member 12 is an elastic element, when it is pressed, it compresses, and thus changing the size of the gap between the carrying part 101 and the flow regulating member 14. In other words, the fluid pressure of the fluid is exerted on the gap controlling member via the flow regulating member 14, so that the gap controlling member 12 can adjust the size of the gap between the carrying part 101 and the flow regulating member 14. Thereby, the flow rate of the fluid out of the first outlet via the gap can be controlled. The flow rate of the fluid out of the first outlet 104 can be controlled within a predetermined range can be thus controlled.

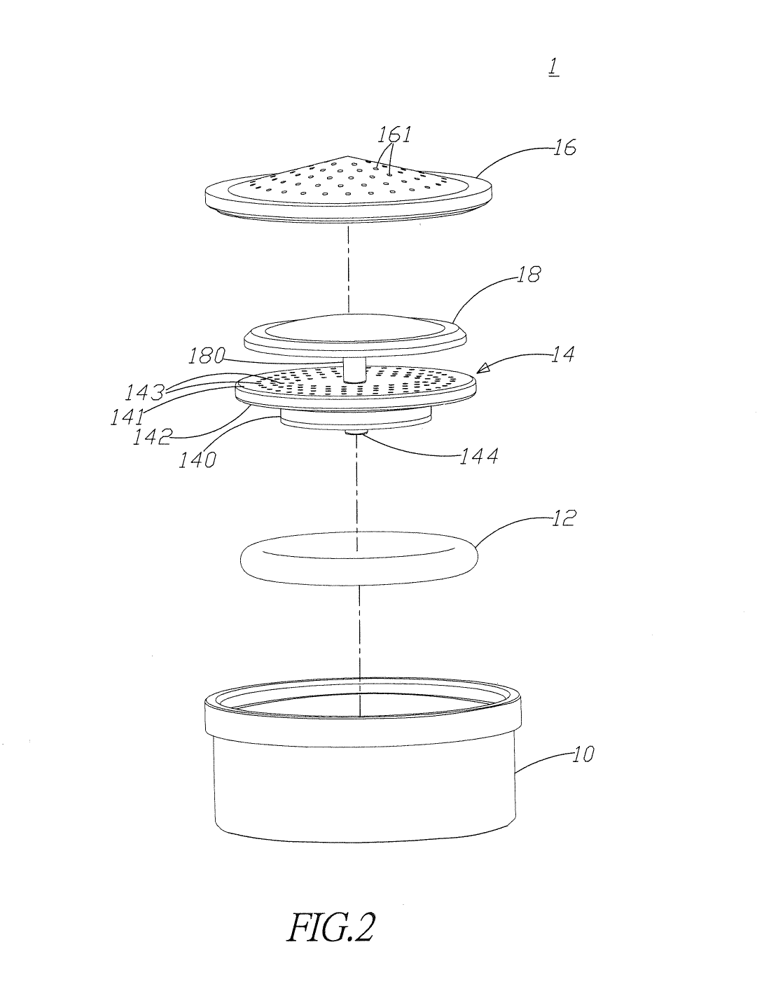

Refer again to FIGS. 2 and 3. The flow regulating member 14 has a first surface 141 and a second surface 142. The first surface 141 faces the inlet 103 of the housing 10; the second surface 142 faces to the carrying part 101 of the housing 10. The flow regulating member 14 according to the present embodiment has a blocking part 140 located on the second surface 142 of the flow regulating member 14, namely, facing the carrying part 101. The blocking part 140 according to the present embodiment is opposite to the first outlet 104. Thereby, there is a gap between the blocking part 140 and the first outlet 104. The gap controlling member 12 is used for controlling the size of the gap between the blocking part 140 and the first outlet 104 and hence controlling the flow rate of the fluid flowing out of the first outlet 104.

The end of the blocking part 140 is protruding. The carrying part 101 has a recessed part 1011 opposite to the end of the blocking part 140. The first outlet 104 is located on the end surface of the recessed part 1011 of the carrying part 101. The cross-sectional shape of the tip of the blocking part 140 according to the present invention is pointed. The cross-sectional shape of the recessed part 1011 corresponds to the one of the tip of the blocking part 140. Nonetheless, the cross-sectional shape of the tip of the blocking part 140 can be rectangular or other shapes once the cross-sectional shape of the recessed part 1011 corresponds to the cross-sectional shape of the tip of die blocking part 140. Thereby, the blocking part 140 matches the recessed part 1011 of the carrying part 101 for controlling the flow rate of the fluid out of first outlet 104. According to an embodiment of the present invention, the blocking part 140 seals the recessed part 1011 completely and thus shutting off the first outlet 104.

Refer again to FIG. 3. The flow regulating member 14 has a first channel 143 transferring through the flow regulating member 14, namely, penetrating the first and second surfaces 141, 142. The first channel 143 according to the present embodiment is comprised of a plurality of perforations. The carrying part 101 corresponds to the first channel 143. Thereby, the fluid flowing from the inlet 103 flows to the gap between the blocking part 140 of the flow regulating member 14 and the first outlet 104 and the gap between the flow regulating member 14 and the second outlet 105 via the first channel 143. At last, the fluid flows out from the first and second outlets 104, 105. In addition, because the second outlet 105 is not blocked by the blocking part 140, the first channel 143 corresponds directly to the second outlet 105. The gap between the flow regulating member 14 and the second outlet 105 according to the present embodiment is greater than the one between the flow regulating member 14 and the first outlet 104. Because there is no blocking part 140 at the location where the flow regulating member 14 corresponds to the second outlet 105, the second outlet 105 will not be influenced by the blocking part 105. When the blocking part 105 of the flow regulating member 14 blocks completely the first outlet 104, the fluid can still drain off from the second outlet 105 and form a normally unobstructed condition.

The flow regulating member 14 according to the present embodiment has a protruding part 144 at its center. The protruding part 144 is located on the second surface 142 of the flow regulating member 14. The carrying part 101 has a sliding groove 106 corresponding to the protruding part 144. The protruding part 144 of the flow regulating member 14 is disposed slidably in the sliding groove 106. When the flow regulating member 14 bears the fluid pressure of the fluid and moves towards the carrying part 101, its protruding part 144 slides along the sliding groove 106 for maintaining flow regulating member's 14 linear motion, namely, up-down movement without deviation. The sliding groove 106 can have fluid flowing therein. Thereby, at least a through hole 1061 is further disposed on the end surface of the sliding groove 106 so that the fluid in the sliding groove 106 can drain off through the through hole 1061 and thus avoiding accumulation of fluid in the sliding groove 106. The accumulation may block the flow regulating member 14 and prevent it from regulating the gap between the regulating member 14 and the carrying part 101. Besides, the non-flowing fluid can produce stink or breed mosquitoes.

It is known from the above that the fluid regulating valve 1 according to the present embodiment is tolerant to damages in long-term usage. The main reason is owing to its larger area by which the fluid strikes the flow regulating member 14; the striking on the flow regulating member 14 is not concentrate on a small area. That is to say, the fluid strikes the flow regulating member 14 uniformly, so that the flow regulating member 14 is tolerant to damages caused the striking of the fluid. Thereby, the fluid regulating valve 1 according to the present embodiment has high reliability, simple structure, and few components, which make it easy for assembling and modularization.

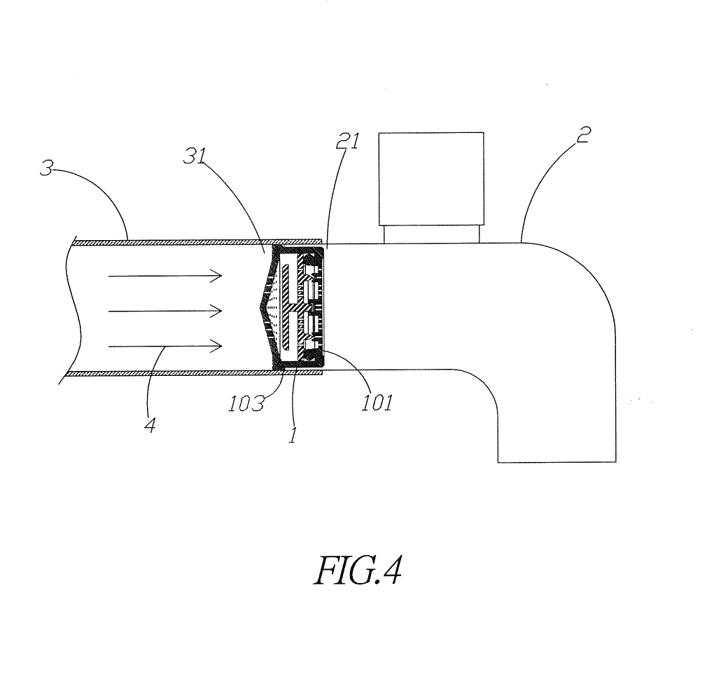

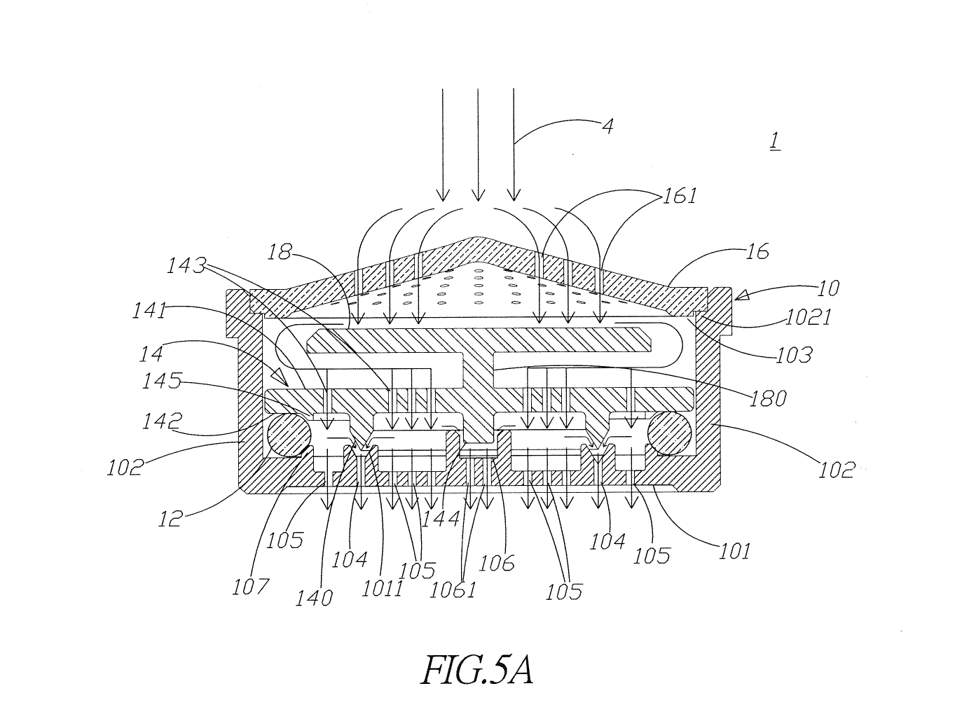

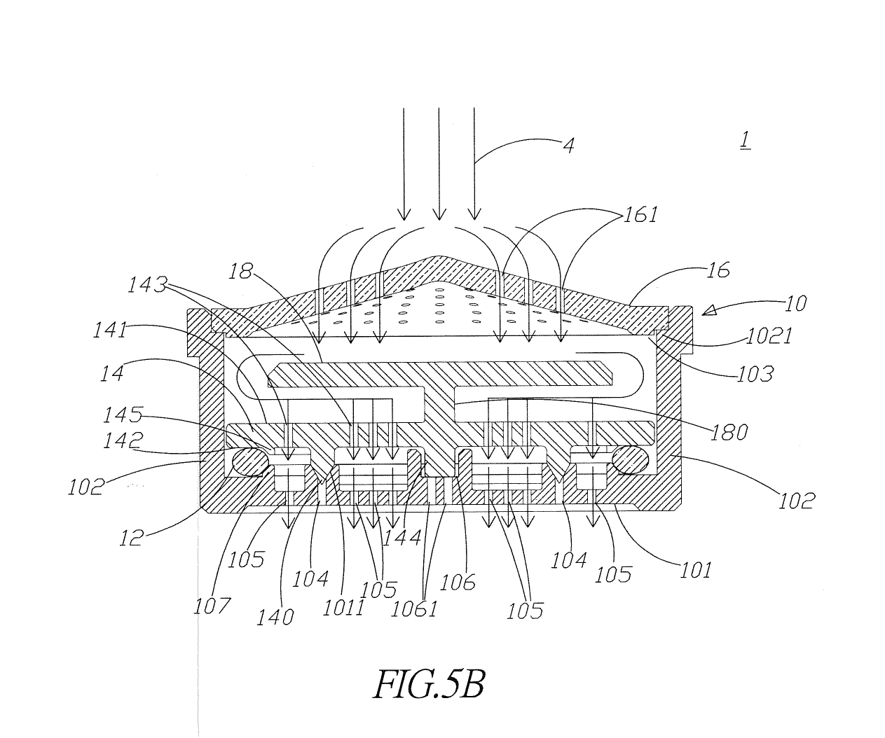

Refer to FIGS. 4, 5A, and 5B. The fluid regulating valve 1 according to the present embodiment can be disposed between an outlet device 2 and an inlet pipe 3. The outlet device 2 can be a tap, a shower nozzle, or other outlet devices. In the present embodiment, the outlet device 2 is a tap for example. The fluid regulating valve 1 is first disposed at an inlet end 21 of the outlet device 2. The carrying part 101 of the housing 10 is plugged into the inlet end 21 with the inlet 103 of the housing facing the inlet pipe 3. Then the inlet end 21 of the outlet device 2 is assembled to an outlet end 31 of the inlet pipe 3. This completes installing the fluid regulating valve 1 between the outlet device 2 and the inlet pipe 3.

When the outlet end 31 of the inlet pipe 3 supplies fluid 4, the fluid 4 first flows from the inlet 103 of the housing 10 into the housing 10 and to the flow regulating member 14. The flow regulating member 14 is struck by the fluid 4. Namely, the fluid 4 exerts pressure on the flow regulating member 14. Thereby, downward pressure is exerted on the flow regulating member 14; the fluid 4 will drive the flow regulating member 14 to move downwards and making the flow regulating member 14 and the blocking part 140 to move towards the first and second inlets 104, 105. The gap controlling member 12 will adjust the size of the gap between the blocking part 140 and the first outlet 104 as well as the gap between the flow regulating member 14 an the second outlet 105. In other words, the flow regulating member 14 will move towards the first and second outlets 104, 105 according to the pressure of the fluid 4, and pass the pressure on to the gap controlling member 12 for adjusting the size of the gap between the flow regulating member 14 and the first outlet 104 as well as the gap between the flow regulating member 14 an the second outlet 105 by means of the gap controlling member 12. The distance by which the flow regulating member 14 moves downwards and the compressed distance of the gap controlling member depend on the downward pressure exerted on the flow regulating member 14 by the fluid 4.

For example, when the pressure of the fluid 4 is smaller, the flow rate if the fluid 4 is smaller, which means the downward pressure on the flow regulating member 14 is smaller too. Thereby, the downward pressure exerted on the gap controlling member 12 by the downward movement of the flow regulating member 14 is smaller too. Hence, the compressed distance of the gap controlling member 12 is also shorter. Consequently, there is a larger gap between the blocking part 140 of the flow regulating member 14 and the first outlet 104 and between the flow regulating member 14 and the second outlet 105. Next, the fluid 4 passes through the first channel 143 of the flow regulating member 14 and to the gap between the blocking part 140 of the flow regulating member 14 and the first outlet 104 and the gap between the flow regulating member 14 and the second outlet 105. Finally, the fluid 4 flows out from the first and second outlets 104, 105. According to the description above, it is known that because the pressure of the fluid 4 is smaller, the gaps between the flow regulating 14 and the first and second outlets 104, 105 are larger. Thereby, the flow rate of the fluid supplied by the fluid regulating valve 1 is greater and is controlled within a predetermined range.

On the contrary, when the pressure of the fluid 4 is larger, the flow rate of the fluid 4 is greater. Then the downward pressure on the flow regulating member 14 is larger, and the downward pressure exerted by the downward movement of the flow regulating member 14 on the gap controlling member 12 is larger too. At this time, the gaps between the blocking part 140 of the flow regulating member 14 and the first outlet 104 and between the flow regulating member 14 and the second outlet 105 are both smaller. However, the gap between the flow regulating member 14 and the second outlet 105 is greater than the one between the blocking part 140 of the flow regulating member 14 and the second outlet 105. This is mainly because the blocking part 140 of the flow regulating member 14 is against the recessed part 1011 of the carrying part 101 and blocks the first outlet 104 and thus making the gap between the blocking part 140 of the flow regulating member and the first outlet 104 smaller or even none. The fluid 4 passes through the first channel 143 of the flow regulating member 14. Most of the fluid 4 flows to the gap between the flow regulating member 14 and the second outlet 105. At last, the fluid 4 flows out form the second outlet 105. According to the description above, it is known that because the pressure of the fluid 4 is greater, the gap controlling member 12 is compressed and making the gap between the flow regulating member 14 and the first outlet 104 smaller. Besides, the gap between the flow regulating member 14 and the second outlet 105 is maintained greater than the one between the flow regulating member 14 and the first outlet 104. Although the flow rate of the fluid supplied to the first outlet 104 is reduced, owing to the greater flow rate of the fluid 4 flowing into the fluid regulating valve 1, the flow rate of the fluid supplied to the second outlet 105 is relatively greater. Thereby, the flow rate of the fluid supplied by the fluid regulating valve 1 is still kept within the predetermined range.

It is known from above that the fluid regulating valve 1 according to the present embodiment mainly uses the flow regulating member 14 to pass the pressure of the fluid 4 on to the gap controlling member 12. The gap controlling member 12 adjusts the gap between the flow regulating member 14 and the first outlet 104 for controlling the cross-sectional area of the fluid 4 flowing through the gap, and thus further controlling the flow rate of the fluid 4 flowing out of the fluid regulating valve 1 within the predetermined range.

In addition, the gap controlling member 12 is disposed in the housing 10 and between the carrying part 101 of the housing 10 and the flow regulating member 14 for providing an appropriate supporting force and supporting the flow regulating member 14. The supporting force provided by the gap controlling member 12 depends on the fluid pressure within a predetermined range. Thereby, within the predetermined range of fluid pressure, the gap controlling member 12 can adjust the gap between the flow regulating member 14 and the first outlet 104 for regulating the flow rate of the fluid 4 flowing out of the first outlet 104. Hence, the flow rate of the fluid 4 flowing out of the fluid regulating valve 1 can be controlled within the predetermined range. Under the condition when the fluid pressure is constant, the gap controlling member 12 will maintain the gap between the flow regulating member 14 and the first outlet 104. That is to say, the cross-sectional area of the gap between the two through which the fluid 4 flows is kept unchanged, and resulting in stable supply of the fluid 4.

The gap controlling member 12 according to the present embodiment is an elastic element. When the flow regulating member 14 is pressed downwards by the pressure of the fluid 4 to the gap controlling member 12, it applies pressure to the gap controlling member 12. Then the gap controlling member 12, which is an elastic element, will produce a reacting force corresponding to the downward force of the flow regulating member 14. The reacting force is just the supporting force. Consequently, the objective of regulating the gap between the flow regulating member 14 and the first outlet 104 can be achieved.

Moreover, the carrying part 101 of the housing 10 further has a first limiting part 107 located close to the surrounding sidewall 102. The flow regulating member 14 further has a second limiting part 145 corresponding to the first limiting part 107 of the housing 10. The gap controlling member 12 is disposed between the first limiting part 107 of the housing 10 and the second limiting part 145 of the flow regulating member 14. Thereby, the location of the gap controlling member 12 can be limited effectively and avoiding displacement of the gap controlling member 12 in the housing 10. It is, of course, allowed to have either the first limiting part 107 of housing 10 or the second limiting part 145 of the flow regulating member 14 only. It is not required to dispose both. The details will not be described further.

Refer again to FIG. 3. The housing 10 of the fluid regulating valve 1 according to the present embodiment further comprises a filtering body 16 having a plurality of filtering holes 161 transferring therethrough. The plurality of filtering holes 161 correspond to and connect with the inlet 103. The plurality of filtering holes 161 filter the impurities contained in the fluid 4 flowing from the inlet pipe 3 (as shown in FIG. 4) and keep the impurities of the fluid 4 from entering the fluid regulating valve 1 for avoiding jams of the impurities in the fluid regulating valve 1. Besides, an end of the surrounding sidewall of the housing 10 according to the present embodiment forms a scarf part 1021. The circumference of the filtering body 16 is scarfed to the scarf part 1021. According to the present embodiment, a single filtering body 16 is adopted. It is also possible to use a multi-layered filtering body 16 for enhancing the filtering effect. The details will not be described further.

Besides, the fluid regulating valve 1 according to the present embodiment further comprises a reverse-flow stop member 18 disposed slidably in the housing 10. The reverse-flow stop member 18 is connected with the flow regulating member 14 and is located between the inlet 103 and the flow regulating member 14. In addition, a fixed gap is formed between the reverse-flow stop member 18 and the flow regulating member 14. Thereby, the fluid 4 flowing in from the inlet 103 can flow to the fixed gap, namely, the space between the reverse-flow stop member 18 and the flow regulating member 14 and to the first channel 143 from the fixed gap between the reverse-flow stop member 18 and the flow regulating member 14. By way of the first channel 143 of the flow regulating member 14, the fluid 4 flows out from the first and second outlets 104, 105. The reverse-flow stop member 18 according to the present embodiment has a spacing part 180 protruding an end surface thereof. In the present embodiment, the spacing part 180 is located at the center of the reverse-flow stop member 18. The spacing part 180 is against the flow regulating member 14 to form the fixed gap between the reverse-flow stop member 18 and the flow regulating member 14.

Furthermore, there is a space between the reverse-flow stop member 18 and the surrounding sidewall 102 of the housing 10. When the fluid 4 flows in from the inlet 103 of the housing 10, the reverse-flow stop member 18, under the pressure of the fluid 4, drives the flow regulating member 14 to move downwards. Meanwhile, the fluid 4 flows into the fixed gap from the space between the reverse-flow stop member 18 and the surrounding sidewall 102 of the housing 10 and to the first channel 143 of the flow regulating member 14. Then the fluid 4 flows from the first channel 143 of the flow regulating member 14 to the first and second outlets 104, 105 and flows out. When the vacuum siphon phenomenon between the housing 10 and the connected outlet device 2 (as shown in FIG. 4) occurs, the reverse-flow stop member 18 is mainly used for preventing the dirty fluid inside the outlet device 2 from flowing reversely to the housing 10 via the first and second outlets 104, 105 and to the inlet pipe 2 (as shown in FIG. 4) from the inlet 103 of the housing 10. The dirty fluid will pollute the inlet pipe 2.

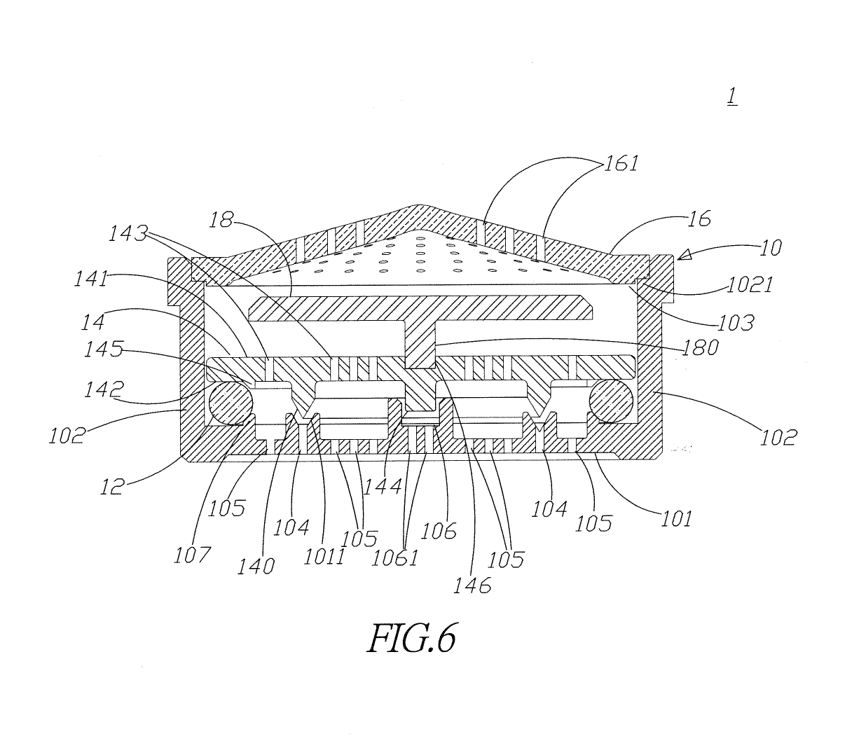

The reverse-flow stop member 18 and the flow regulating member 14 are formed integrally. The reverse-flow stop member 18 according to the present embodiment is assembled to the flow regulating member 14, as shown in FIG. 6. The first surface 141 of the flow regulating member 14 has an assembling part 146 at its center. The assembling part 146 is used for assembling the spacing part 180 of the reverse-flow stop part 18. The assembling part 146 of the flow regulating member 14 according to the present embodiment corresponds to the spacing part 180 and is a notch for the spacing part 180 to attach to. The present embodiment is only an embodiment of the present invention. There are other ways to assemble the assembling part 146 of the flow regulating member 14 and the spacing part 180 of the reverse low stop member 18. The details will not be described further.

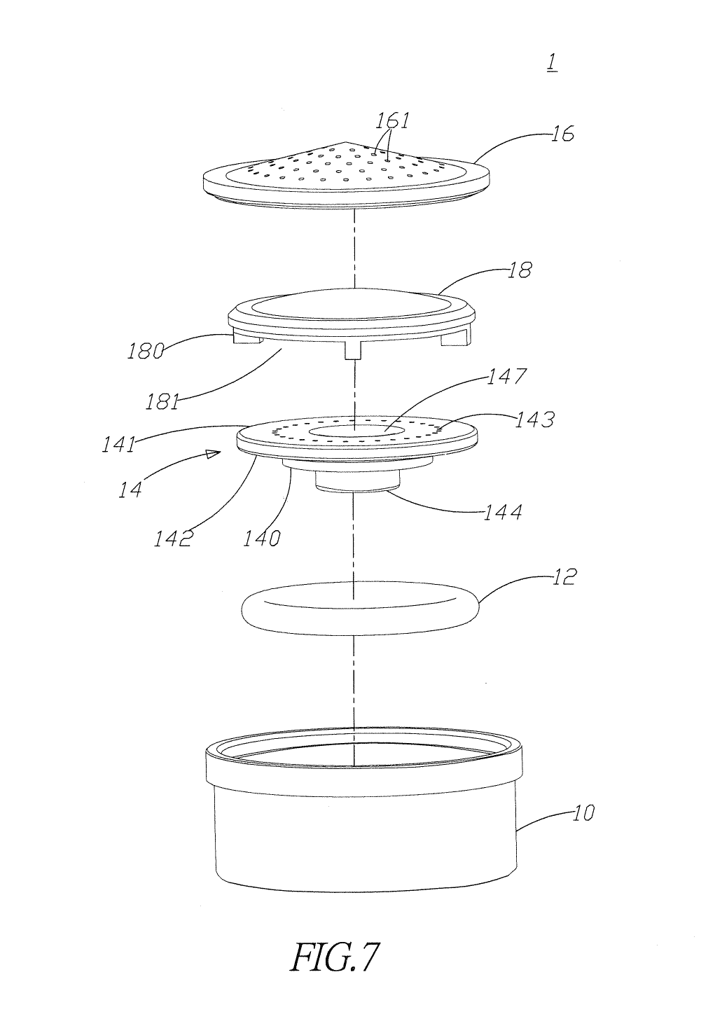

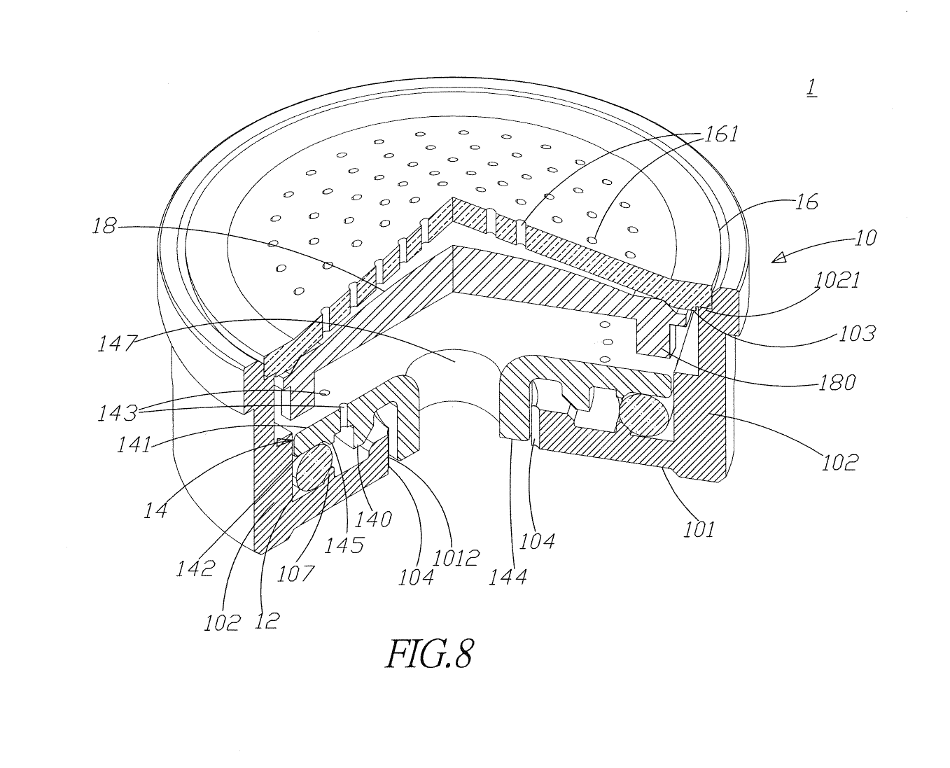

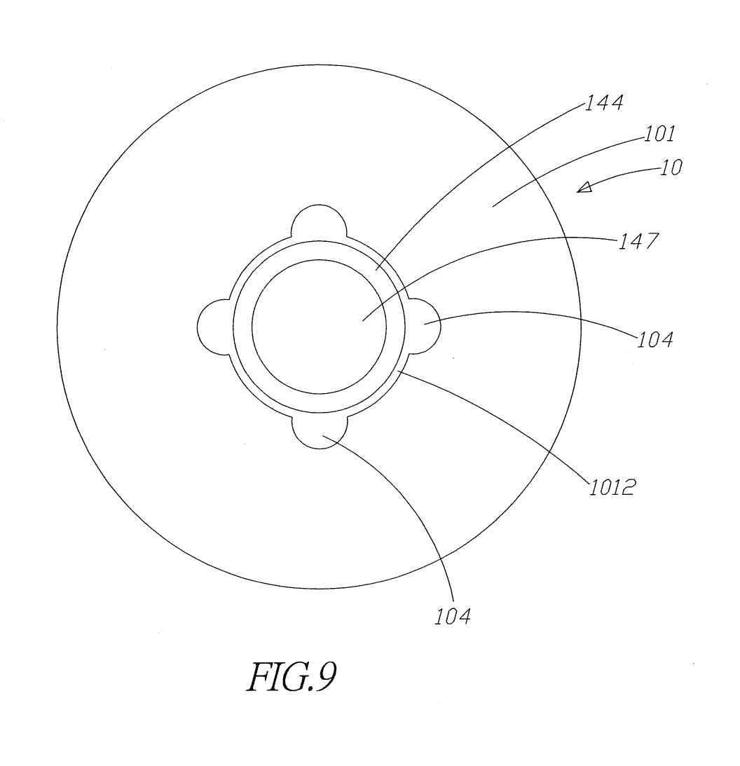

FIGS. 7 and 8 show exploded and partial cross-sectional views according to a third embodiment of the present invention. As shown in the figure, the difference between the present embodiment and the first embodiment is that the carrying part 101 of the flow regulating valve 1 according to the present embodiment has a through hole 1012; the flow regulating member 14 further has a protruding part 144 at its center. The protruding part 144 is disposed slidably through the through hole 1012. The flow regulating member 14 according to the present embodiment further has a second channel 147 penetrating the protruding part 144 of the flow regulating member 14 and connecting with the through hole 1012 of the carrying part 101. The second channel 147 is equivalent to the second outlet 105 (as shown in FIG. 3) according to the first embodiment. Thereby, the fluid will not flow through the gap between the flow regulating member 14 and the carrying part 101. The fluid will drain off from the second channel 147 of the flow regulating member 14 to the through hole 1012 directly, and thus forming a normally unobstructed condition. Besides, the first channel 143 of the flow regulating member 14 only connects with the first outlet 104 by way of the gap between of flow regulating member 14 and the carrying part 101. Accordingly, the fluid flowing in from the first channel will drain off from the first outlet 104. Moreover, as shown in FIG. 9, the first outlet 104 connects with the through hole 1012 of the carrying part 101. Hence, the fluid flowing into the first channel 143 will flow to the through hole 1012 from the first outlet 104 and drain off.

Refer again to FIG. 8. The blocking part 140 of the flow regulating member 14 is located between the first channel 143 and the first outlet 104. When the flow rate of the fluid if greater, the downward pressure exerted on the blocking part 140 of the flow regulating member 14 will be greater, making no gap between the blocking part 140 and the carrying part 101. The blocking part 140 will be against the carrying part 101, and thus blocking the fluid flowing in from the first channel 143 from flowing to the first outlet 104. On the contrary, when the flow rate of the fluid is smaller, the downward pressure exerted on the flow regulating member 14 will be less. A certain gap will be maintained between the blocking part 140 and the carrying part 101. The fluid flowing in from the first channel 143 will flow to the first outlet 104 by transferring the gap.

Refer to FIG. 9. The first outlet 104 according to the present embodiment is located on the sidewall of the through hole 1012 and connects with the through holes 1012 of the carrying part 101. When there is a gap between the blocking part 140 of the flow regulating member 14 and the carrying part 101, the fluid flows form the first channel 143 of the flow regulating member 14 to the first outlet 104 via the gap and drains off from the first outlet 104. Then the fluid drained off from the first outlet 104 converges with the fluid drained off from the second channel 147 connecting with the through hole 1012 at the end of the through hole 1012.

The reverse-flow stop member 18 according to the present embodiment is different from the one according to the first embodiment. The difference is that the reverse-flow stop member 18 according to the present embodiment is against the top of the flow regulating member 14 and does not connect with the flow regulating member 14. The bottom of the reverse-flow stop member 18, as the one according to the first embodiment, has the spacing part 180. However, the spacing part 180 according to the present embodiment is an annular protruding member having at least a notch 181 (as shown in FIG. 7). Namely, the spacing part 180 according to the present embodiment has a plurality of protruding parts. There is an interval, which is just the notch 181, between two adjacent protruding parts. Thereby, the fluid flowing in from the inlet 103 will flow to the flow regulating member via the notch 181.

The spacing part 180 is against the first surface 141 of the flow regulating member 14. When the fluid flows in from the inlet 103 of the housing 10, the reverse-flow stop member 18 moves by the downward pressure of the fluid. The spacing part 180 pushes against the first surface 141 of the flow regulating member 14, and applies the pressure exerted by the reverse-flow stop member 18 on the flow regulating member uniformly as well as driving the flow regulating member 14 to move downwards. In addition, the spacing part 180 will maintain the fixed gap between the reverse-flow stop member 18 and the flow regulating member 14, so that the fluid can flow to the first and second channels 143, 147 of the flow regulating member 14.

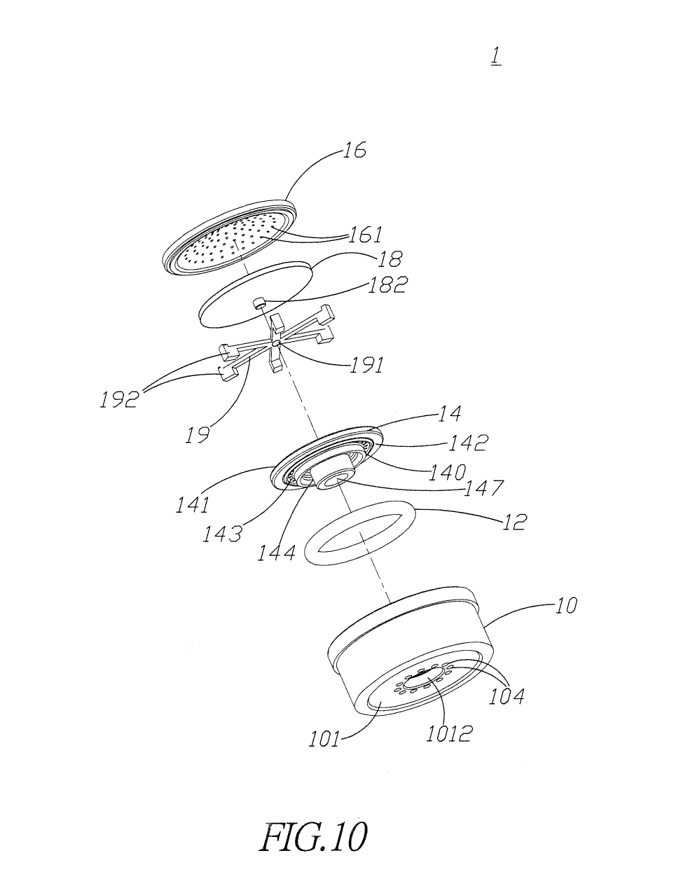

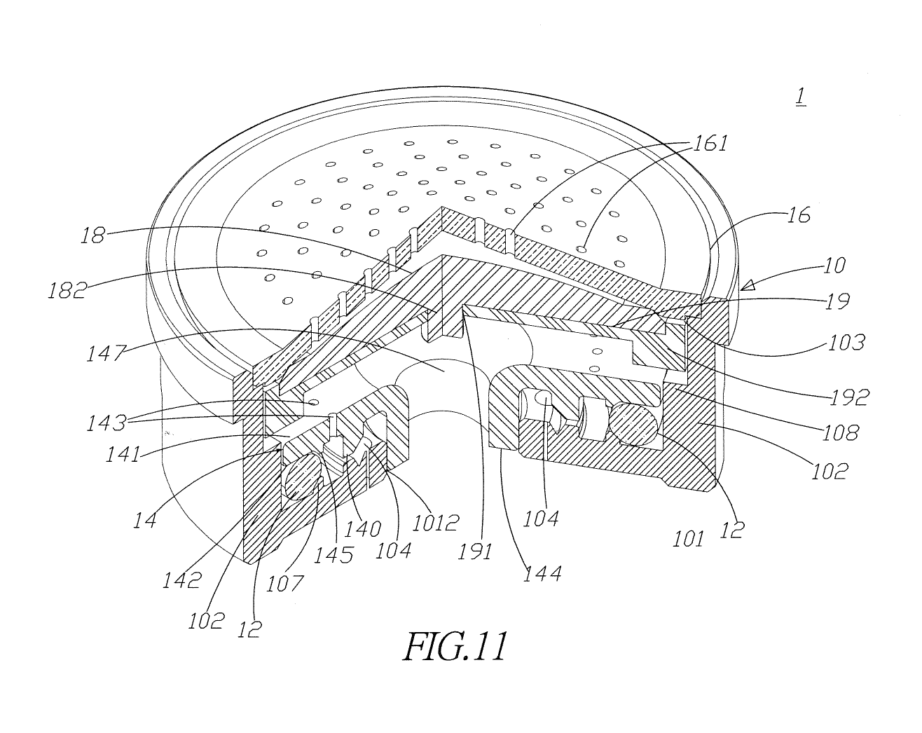

FIGS. 10 and 11 show exploded and partial cross-sectional views according a fourth embodiment of the present invention. As shown in the figures, the difference between the present embodiment and the third embodiment is that the fluid regulating valve 1 according to the present embodiment further comprises a spacing member 19 located between the reverse-flow stop member 18 and the flow regulating member 14. Besides, the present invention further comprises a wedging part 108 formed on the housing 10, namely, at an end of the surrounding sidewall 102. The wedging part 108 is located above the flow regulating member 14. The circumference of the spacing member 19 is wedged in the wedging part 108 of the housing 10 for fixing itself in the housing 10. The reverse-flow stop member 18 has a protruding part 182 at its center. The spacing member 19 has a through hole 191 at its center corresponding to the protruding part 182 of the reverse-flow stop member 18. The protruding part 182 of the reverse-flow stop member 18 is disposed slidably in the through hole 191 of the spacing member 19. When the carrying part 101 produces reversed fluid, the reversed fluid will strike the reverse-flow stop member 18, which will be driven by the fluid and drive the spacing member 19 to move along the surrounding sidewall 102. Because the circumference of the spacing member 19 is adjacent tightly to the surrounding sidewall 102, the reverse-flow stop member 18 will not be tilted by the strike of the fluid. Thereby, drainage of the reversed fluid from the inlet 103 of the housing can be avoided.

The circumference of the spacing member 19 according to the present embodiment further comprises protrudingly a spacing part 192. The spacing part 192 is against the wedging part 108 for maintained a fixed gap between the reverse-flow stop member 18 and the flow regulating member 14. When the fluid flows in from the inlet 103 and presses the reverse-flow stop member 18, the spacing part 192 pushes against the wedging part 108 for keeping the fixed gap between the reverse-flow stop member 18 and the flow regulating member 14. By using the through hole 191 as the center, the spacing member 19 according to the present embodiment extends a plurality of bar-shaped bodies to the circumference of the reverse-flow stop member 18 (as shown in FIG. 10). Between two of the plurality of bar-shaped bodies, there is a space. In addition, the spacing parts 192 are formed at the ends of the plurality of bar-shaped bodies. Moreover, there is also a gap between the circumference of the reverse-flow stop member 18 and the surrounding sidewall 102. Thereby, the fluid flowing in from the inlet 103 can flow to the flow regulating member 14 via the gap between the circumference of the reverse-flow stop member 18 and the surrounding sidewall 102 and via the space between the spacing member 19 and the plurality of bar-shaped bodies.

According to the third embodiment, the fluid flowing from the first outlet 104 will drain off from the through hole 1012 connecting with the first outlet 104 (as shown in FIG. 8). The first outlet 104 according to the present embodiment is formed on the carrying part 101 between the first channel 143 and the through hole 1012. The first outlet 104 according to the present embodiment is a hole penetrating the carrying part 101 of the housing 10 and not connecting with the through hole 1012 of the carrying part 101. When there is a gap between the blocking part 140 of the flow regulating member 14 and the carrying part 101, the fluid will flow in via the first channel 143, to the first outlet 104 by way of the gap, and drain off. The fluid will not converge with the fluid from the second channel 147 of the flow regulating member 14.

To sum up, the present invention provides a fluid regulating valve, which can regulate the flow rate of the fluid according to the fluid pressure. Thereby, as the fluid pressure varies, the supplied flow rate of the fluid regulating valve can be controlled within a predetermined range. The fluid regulating valve according to the present invention is tolerant to damages in long-term usage. Hence, the fluid regulating valve according to the present invention has high reliability. In addition, the fluid regulating valve according to the present invention has a simple structure with few components, which facilitates assembling and modularization. Furthermore, the fluid regulating valve according to the present invention has a reverse-flow stop member for preventing dirty reversed fluid from flowing back to the fluid regulating valve.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A fluid regulating valve, comprising:
a housing, having an inlet and a carrying part and said carrying part having a first outlet;
a flow regulating member, disposed in said housing, and located between said inlet and said first outlet for transferring a fluid pressure of a fluid; and
a gap controlling member, being an elastic element, disposed in said housing, adjacent to and between said carrying part and said flow regulating member for regulating the gap between said carrying part and said flow regulating member, and said inlet and said first outlet connecting with said gap;
where said fluid flows into said housing via said inlet, flows into said gap via said flow regulating member, drains off from said first outlet, and said fluid pressure of said fluid exerts pressure on said gap controlling member via said flow regulating member for controlling the flow rate of said fluid draining off said first outlet via said gap by adjusting the size of said gap using said gap controlling member.

2. The fluid regulating valve of claim 1, wherein said flow regulating member has a blocking part, said gap controlling member controlling the gap between said blocking part and said carrying part, said blocking part facing said first outlet of said carrying part, the end of said blocking part being pointed, said carrying part having a recessed part facing the end of said blocking part, and said first outlet located on the end surface of said recessed part of said carrying part.

3. The fluid regulating valve of claim 1, wherein said flow regulating member has a blocking part, said gap controlling member controlling the gap between said blocking part and said carrying part, said flow regulating member further having a first channel transferring through said flow regulating member, and said blocking part located between said first channel and said first outlet.

4. The fluid regulating valve of claim 1, wherein said flow regulating member has a first channel transferring through said flow regulating member, said carrying part having a sliding groove, said flow regulating member having a protruding part disposed slidably in said sliding groove of said carrying part, said sliding groove having a through hole on the end surface, and said flow regulating member and said carrying part having a protruding limiting part, respectively, for limiting said gap controlling member.

5. The fluid regulating valve of claim 1, wherein said carrying part has a second outlet, said flow regulating member having a first channel facing said second outlet, and the gap between said flow regulating member and said second outlet being greater than the gap between said flow regulating member and said first outlet.

6. The fluid regulating valve of claim 1, wherein said carrying part has a through hole, said flow regulating member has a protruding part disposed slidably in said through hole, said through hole of said carrying part connects with said first outlet, and said flow regulating member has a second channel transferring through said protruding part of said flow regulating member and connecting with said through hole of said flow regulating member.

7. The fluid regulating valve of claim 1, and further comprising a reverse-flow stop member disposed slidably in said housing, located between said inlet and said flow regulating member, having a spacing part on the end surface of said reverse-flow stop member and against said flow regulating member and forming a fixed gap between said reverse-flow stop member and said flow regulating member, said spacing part being an annular protruding member having a notch, and said housing further comprising a surrounding sidewall surrounding the circumference of said carrying part and forming a space between said reverse-flow stop member and said surrounding sidewall of said housing.

8. The fluid regulating valve of claim 1, and further comprising:
a reverse-flow stop member;
a spacing member; and
a wedging part, formed on said housing and above said flow regulating member;
where said reverse-flow stop member is located between said inlet and said flow regulating member, said spacing member is located between said reverse-flow stop member and said flow regulating member, the circumference of said spacing member is wedged in said wedging part of said housing, said reverse-flow stop member further has a protruding part, said spacing member has a through hole, said protruding part of said reverse-flow stop member is disposed slidably in said through hole of said spacing member, and said spacing member has a protruding spacing part wedged in said wedging part of said housing.

9. The fluid regulating valve of claim 1, and further comprising a reverse-flow stop member disposed in said housing and connecting with said flow regulating member, and forming a fixing gap between said reverse-flow stop member and said flow regulating member.

10. The fluid regulating valve of claim 1, and further comprising:
a filtering body, having a plurality of filtering holes, and connecting with said inlet; and
a surrounding sidewall, surrounding the circumference of said carrying part, having a scarf part at an end of said surrounding sidewall, and said circumference of said filtering body scarfed to said scarf part.
